(19) United States
(12) Patent Application Publication
(10) Pub. No.: US 2011/0010988 A1
(43) Pub. Date: Jan. 20, 2011

(54) Universal Underground Receptacle for a Cemetery Flower Vase Cylinder

(76) Inventor: Michael Lanoha, Omaha, NE (US)

Correspondence Address: THOMTE LAW OFFICE, L.L.C., 2120 S. 72ND STREET, SUITE 1111, OMAHA, NE, 68124, US

(21) Appl. No.: 12/460,260

(22) Filed: Jul. 16, 2009

(51) Int. Cl. A01G 5/04; A47G 7/00; A01G 9/02; A61G 17/007

(52) U.S. Cl. 47/41.1

(57) ABSTRACT

A universal underground receptacle for a cemetery flower vase cylinder is described wherein the receptacle is preferably comprised of recycled rubber tire material and is designed to receive a flower vase cylinder which has a vase ring attached to the upper end thereof so that a flower vase may be secured to the vase ring in either a display position or an inverted stored position.

### BACKGROUND OF THE INVENTION

1. Field of the Invention

This invention relates to a universal underground receptacle for a cemetery flower vase cylinder and more particularly to a universal underground receptacle for a cemetery flower vase cylinder which is comprised of recycled rubber tire material.

2. Description of the Related Art

Most cemetery flower vases are manufactured and sold as a kit of two or three pieces that includes: (1) a vase for the flowers; (2) a vase ring to hold the vase upright and above the ground when on display; and (3) a vase cylinder that the vase ring is attached to either by screws or rivets with the cylinder being comprised of plastic or metal and which is designed to store the flower vase in an inverted position below ground level when not in use.

Normally, the vase cylinder is positioned in the ground adjacent the grave site but most cemeteries will not install the cylinder directly into the ground. Instead, cemeteries and cemetery vendors construct cement forms that are set around the cylinder of the vase and filled with concrete. This serves as a base for the vase cylinder and a necessary practice that is time consuming and expensive. The vase products used in the industry results in one of the most common complaints fielded in the cemetery industry. Unfortunately, it is usually an expensive problem to remedy. There is usually no quality control or restriction on vases delivered to cemeteries by either the mortuary or monument company. These complaints include: (1) the vase is stuck in the vase cylinder and personal assistance is needed; (2) the concrete in which the vase cylinder is embedded becomes cracked or settles into the ground; (3) the vase sinks into the ground and personal assistance is needed to raise the vase; (4) the vase is full of mud and needs cleaning; (5) the vase ring/holder is broken and will not hold the vase; (6) the vase ring is missing; (7) the vase is broken; and (8) the emplacement of the concrete is usually a two-day process (curing) before the vase is ready for installation. It is therefore a need to provide a universal underground receptacle for a cemetery flower vase cylinder which does not require the use of concrete.

### SUMMARY OF THE INVENTION

This Summary is provided to introduce a selection of concepts in a simplified form that are further described below in the Detailed Description. This Summary is not intended to identify key aspects or essential aspects of the claimed subject matter. Moreover, this Summary is not intended for use as an aid in determining the scope of the claimed subject matter.

A universal underground receptacle for a cemetery flower vase cylinder is disclosed comprising a first vase cylinder having upper and lower ends with the first vase cylinder adapted to be placed in the ground so that the upper end thereof is positioned at approximately ground level. The first vase cylinder is preferably comprised of recycled rubber tire material. The first vase cylinder may be comprised of plastic or a combination of plastic and recycled rubber tire material. A second vase cylinder is positioned in the first vase cylinder and has upper and lower ends. A vase ring is mounted on the upper end of the second vase cylinder. A flower vase is also provided having upper and lower ends. The lower end of the flower vase is adapted to be secured to the vase ring so that the flower vase may be positioned in an upright display position. The flower vase is also adapted to be selectively inserted into the vase ring and the second vase cylinder in an inverted storage position. In the preferred embodiment, the first vase cylinder has a perforated bottom. The first vase cylinder may be comprised of multiple pieces or parts. The first vase cylinder has a weight sufficient to maintain the first vase cylinder in the ground.

It is therefore a principal object of the invention to provide an improved universal underground receptacle for a flower vase cylinder.

A further object of the invention is to provide a universal underground receptacle for a cemetery flower vase cylinder which is preferably comprised of recycled rubber tire material.

A further object of the invention is to provide a universal underground receptacle for a cemetery flower vase cylinder which may be comprised of recycled rubber tire material, plastic or a combination of recycled rubber tire material and plastic.

A further object of the invention is to provide a universal underground receptacle for a cemetery flower vase cylinder which eliminates the need for a concrete foundation.

A further object of the invention is to provide a universal underground receptacle for a cemetery flower vase cylinder which will minimize or eliminate the problems associated with a concrete receptacle.

A further object of the invention is to provide a universal underground receptacle for a cemetery flower vase cylinder which will not corrode, deteriorate, etc.

Yet another object of the invention is to provide a universal underground receptacle for a cemetery flower vase cylinder which may be constructed of multiple parts.

These and other objects will be apparent to those skilled in the art.

### BRIEF DESCRIPTION OF THE DRAWINGS

Non-limiting and non-exhaustive embodiments of the present invention are described with reference to the following figures, wherein like reference numerals refer to like parts throughout the various views unless otherwise specified.

FIG. 1 is a perspective view illustrating a grave site wherein a pair of cemetery flower vases are illustrated with one of the flower vases being in an upright condition and the other flower vase being in its stored position.

FIG. 2 is an exploded perspective view of the universal underground receptacle of this invention for use with a cemetery flower vase cylinder and flower vase;

FIG. 3 is a sectional view of the universal underground receptacle of this invention embedded in the ground with the broken lines illustrating the stored position of the flower vase;

FIG. 4 is a perspective view of the universal underground receptacle of this invention;

FIG. 5 is an exploded perspective view of a modified form of the universal underground receptacle of this invention;

FIG. 6 is an exploded perspective view of a further modified form of the universal underground receptacle of this invention;

FIG. 7 is a perspective view of the bottom portion of the embodiment of FIG. 6; and

FIG. 8 is a perspective view of a shim which may be used with the embodiments of FIGS. 5 and 6.

### DESCRIPTION OF THE PREFERRED EMBODIMENT

Embodiments are described more fully below with reference to the accompanying figures, which form a part hereof and show, by way of illustration, specific exemplary embodiments. These embodiments are disclosed in sufficient detail to enable those skilled in the art to practice the invention. However, embodiments may be implemented in many different forms and should not be construed as being limited to the embodiments set forth herein. The following detailed description is, therefore, not to be taken in a limiting sense in that the scope of the present invention is defined only by the appended claims.

In FIG. 1, the numeral 10 refers generally to a grave site wherein a tombstone or monument 12 is positioned on the ground. The numerals 14 and 16 refer to cemetery flower vases which are positioned adjacent the tombstone 12 with the cemetery vase 14 being shown in a display position and the flower vase 16 being shown in its stowed position.

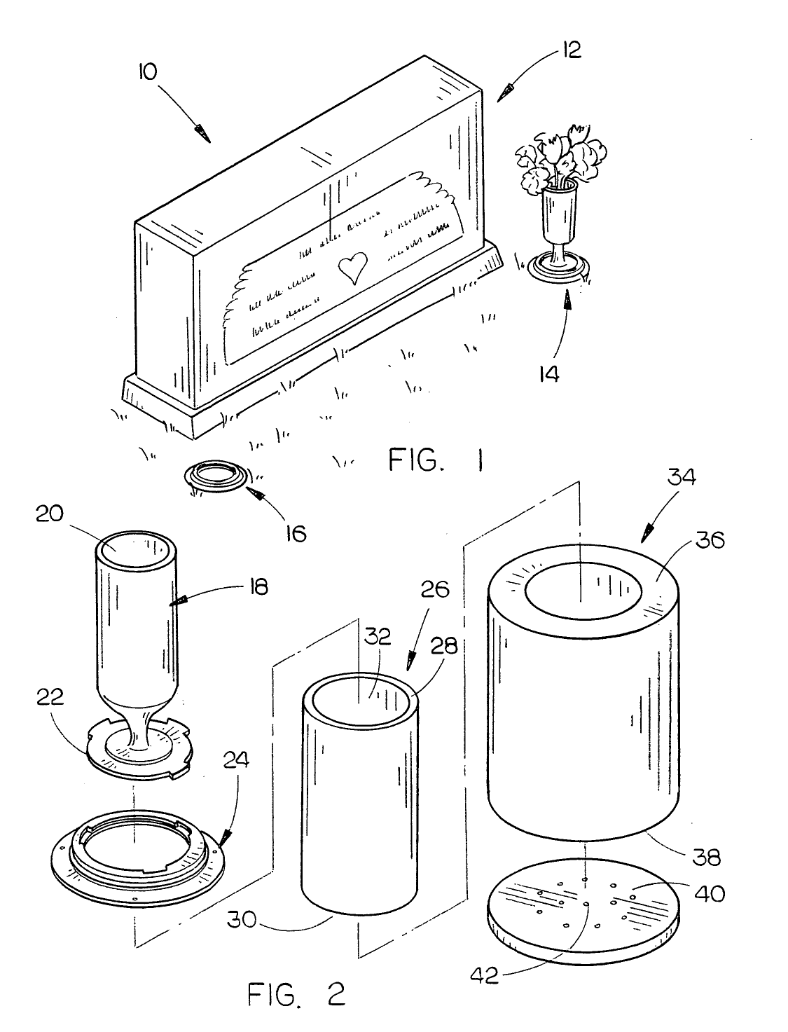

With respect to FIG. 2, the numeral 18 refers to a conventional cemetery vase having a flower receiving portion 20 and a vase 22. The vase 22 of the vase 18 is designed to be secured to a vase ring 24 of conventional design in conventional fashion. The numeral 26 refers to a conventional vase cylinder having an upper end 28, lower end 30 and a central opening 32 extending between the upper and lower ends thereof. The vase ring 22 is secured to the vase cylinder 26 in conventional fashion.

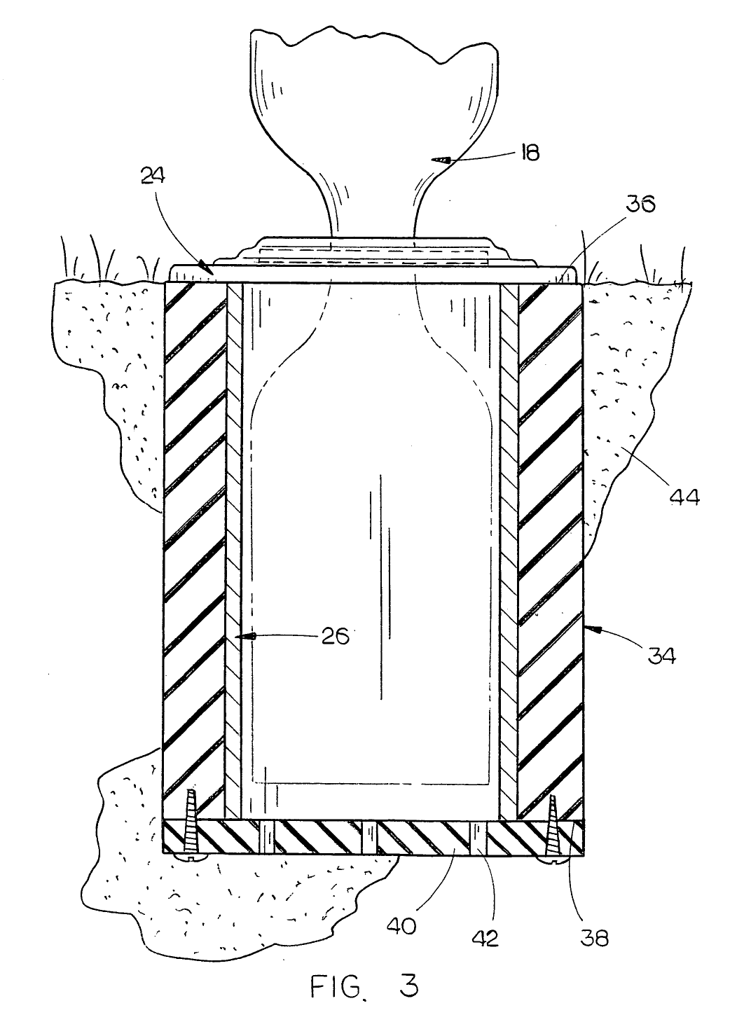

The universal underground receptacle for a cemetery flower vase cylinder of this invention is designated by the reference numeral 34 in FIG. 2 and includes an upper end 36 and a lower end 38. The receptacle 34 is preferably comprised of recycled rubber tire material and has a weight and thickness sufficient so that the weight of the receptacle 34 will cause the receptacle 34 to remain in the ground. Although recycled rubber tire material is preferred, the receptacle 34 may be comprised of rubber, plastic or a combination of rubber and plastic. The lower end of the receptacle 34 is closed by a bottom wall 40 having perforations 42 therein. Bottom wall 40 may be secured to receptacle 34 by glue or screws. As seen in FIG. 3, the receptacle 34 is embedded in the ground adjacent the grave site so that the upper end 36 thereof is at approximately ground level.

The vase cylinder 26 is positioned within the receptacle 34 as seen in FIG. 3 with the vase ring 24 being positioned at the upper end of the cylinder 26 so that the vase 18 may be secured thereto in the display position as illustrated by solid lines in FIG. 3 or inverted and inserted downwardly into the interior of the cylinder 26 as illustrated by broken lines in FIG. 3.

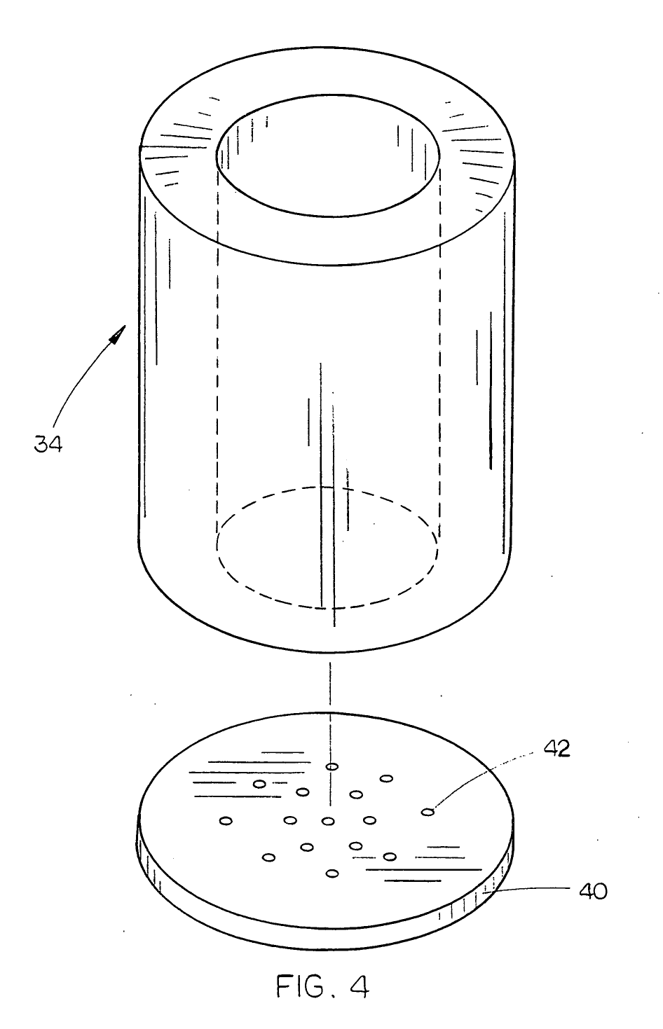

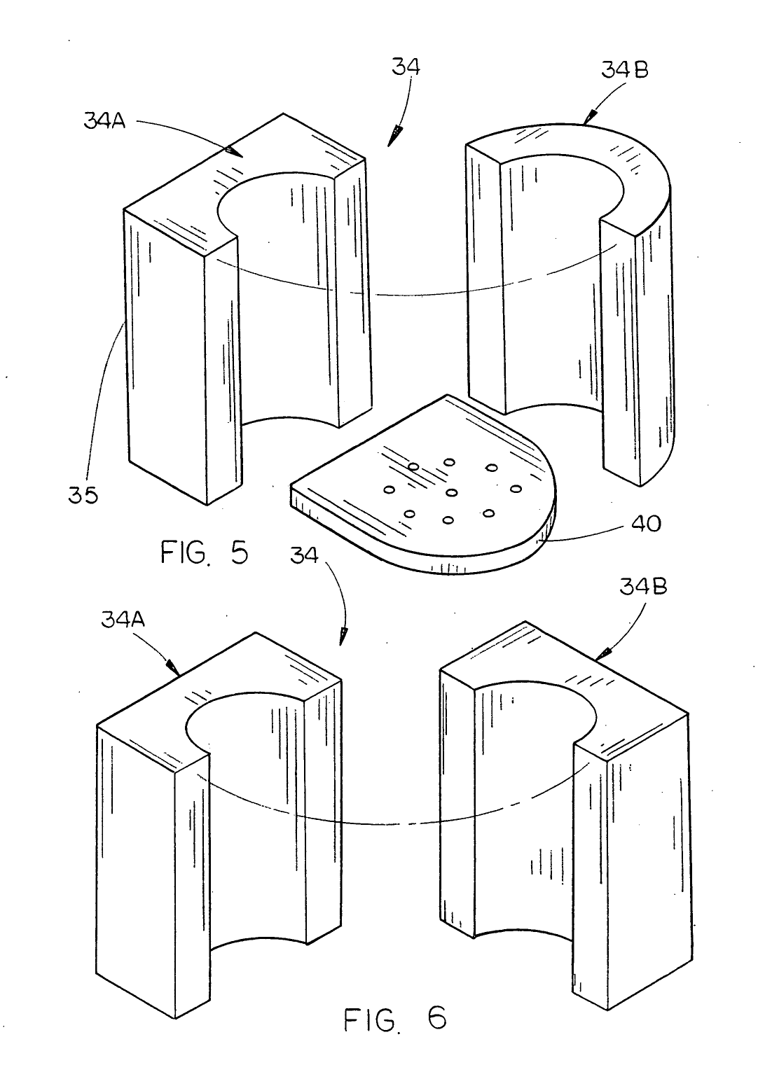

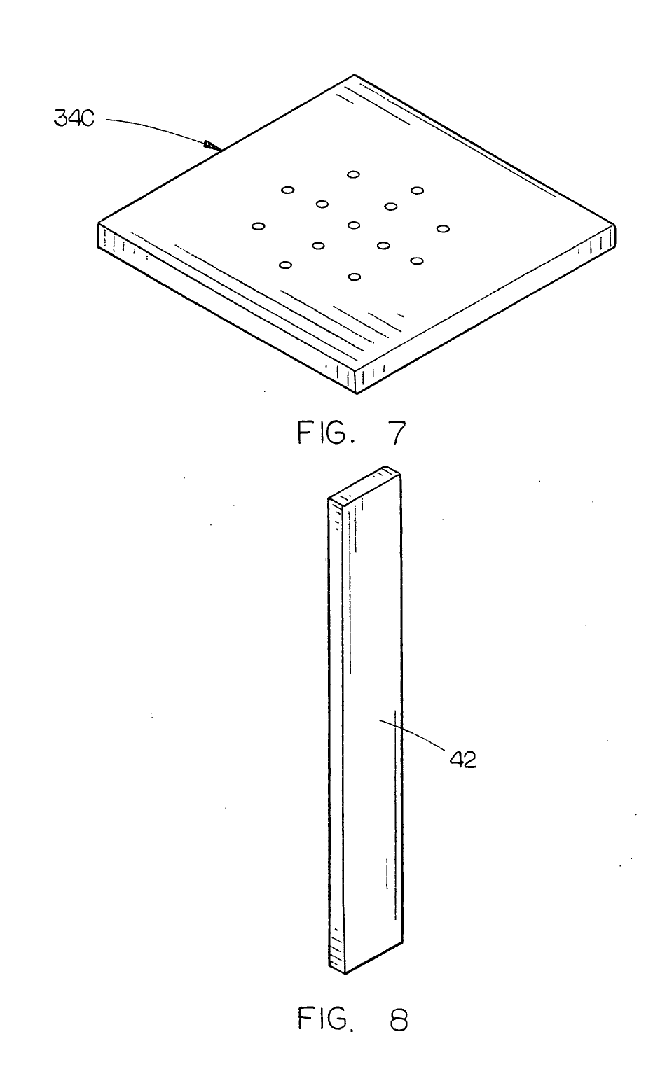

Although it is preferred that the receptacle 34 be comprised of a single piece as illustrated in FIG. 4, the receptacle may be comprised of two portions or parts 34A and 34B as illustrated in FIG. 5 with the bottom 40 being a third component or part which is glued or screwed to the lower end of parts 34A and 34B. Part 34A has a straight back wall 35 so that the receptacle 34 may be closely positioned adjacent the foundation of the monument 12 if so desired. In FIG. 6, a modified form of the receptacle 34 is illustrated wherein the receptacle is comprised of parts 34A and 34B with the perforated bottom 34C being secured to the parts 34A and 34B by glue or screws.

FIG. 8 illustrates a rectangular shim or spacer 42 which may be placed between the mating side edges of the parts 34A and 34B in the embodiments of FIGS. 5 and 6 to increase the opening therebetween to accommodate a larger vase.

In use, the receptacle 34 is embedded in the ground as illustrated in FIG. 3 1and does not require the use of concrete which may crack or sink. Inasmuch as the receptacle 34 may be easily removed from the ground and replaced or repaired, the same is extremely convenient to install and to use. Inasmuch as the use of concrete has been eliminated, the assembly may be easily repaired, replaced or maintained without special assistance. The receptacle of this invention is extremely to install and takes very little time to install. The receptacle of this invention reduces or eliminates the many attendant problems associated with the use of concrete.

Further, there is a much better chance that a broken or malfunctioning vase has restoration options that are not available with concrete.

Thus it can be seen that the invention accomplishes at least all of its stated objectives.

Although the invention has been described in language that is specific to certain structures and methodological steps, it is to be understood that the invention defined in the appended claims is not necessarily limited to the specific structures and/or steps described. Rather, the specific aspects and steps are described as forms of implementing the claimed invention. Since many embodiments of the invention can be practiced without departing from the spirit and scope of the invention, the invention resides in the claims hereinafter appended.

1. A cemetery flower vase assembly comprising:
a first vase cylinder having upper and lower ends, and inner and outer surfaces;
said first vase cylinder adapted to be placed in the ground so that said upper end thereof is positioned at approximately ground level;
said first vase cylinder being comprised of a rubber material;
a second vase cylinder positioned in said first vase cylinder and having upper and lower ends, and inner and outer surfaces;
said outer surface of said second vase cylinder being in close proximity to said inner surface of said first vase cylinder;
a vase ring mounted on said upper end of said second vase cylinder;
a flower vase having upper and lower ends;
said lower end of said flower vase adapted to be secured to said vase ring so that said flower vase is positioned in an upright display position;
said flower vase adapted to be selectively inserted into said vase ring and said second vase cylinder in an inverted storage position.

2. The cemetery flower vase assembly of claim 1 wherein said first vase cylinder has a perforated bottom.

3. The cemetery flower vase assembly of claim 1 wherein said first vase cylinder is comprised of two pieces.

4. The cemetery flower vase assembly of claim 1 wherein said first vase cylinder is comprised of multiple parts.

5. The cemetery flower vase assembly of claim 1 wherein said first vase cylinder has a weight sufficient to maintain said first vase cylinder in the ground.

6. The cemetery flower vase assembly of claim 1 wherein said second vase cylinder is comprised of a plastic material.

7. The cemetery flower vase assembly of claim 1 wherein said second vase cylinder is comprised of a metal material.

8. The cemetery flower vase assembly of claim 1 wherein said rubber material is recycled rubber tire material.

9. A cemetery flower vase assembly comprising:
a first vase cylinder having upper and lower ends, and inner and outer surfaces;
said first vase cylinder adapted to be placed in the ground so that said upper end thereof is positioned at approximately ground level;
said first vase cylinder being comprised of a plastic material;
a second vase cylinder positioned in said first vase cylinder and having upper and lower ends, and inner and outer surfaces;
said outer surface of said second vase cylinder being in close proximity to said inner surface of said first vase cylinder;
a vase ring mounted on said upper end of said second vase cylinder;
a flower vase having upper and lower ends;
said lower end of said flower vase adapted to be secured to said vase ring so that said flower vase is positioned in an upright display position;
said flower vase adapted to be selectively inserted into said vase ring and said second vase cylinder in an inverted storage position.

10. A cemetery flower vase assembly comprising:
a first vase cylinder having upper and lower ends, and inner and outer surfaces;
said first vase cylinder adapted to be placed in the ground so that said upper end thereof is positioned at approximately ground level;
said first vase cylinder being comprised of a plastic and rubber material;
a second vase cylinder positioned in said first vase cylinder and having upper and lower ends, and inner and outer surfaces;
said outer surface of said second vase cylinder being in close proximity to said inner surface of said first vase cylinder;
a vase ring mounted on said upper end of said second vase cylinder;
a flower vase having upper and lower ends;
said lower end of said flower vase adapted to be secured to said vase ring so that said flower vase is positioned in an upright display position;
said flower vase adapted to be selectively inserted into said vase ring and said second vase cylinder in an inverted storage position.

11. The cemetery flower vase assembly of claim 10 wherein said rubber material is recycled rubber tire material.

12. The cemetery flower vase assembly of claim 4 further including shims for placement between parts of the receptacle.
